(19) United States
(12) Patent Application Publication
(10) Pub. No.: US 2023/0373034 A1
(43) Pub. Date: Nov. 23, 2023

(54) METHOD FOR SEPARATING A WORKPIECE

(71) Applicant: TRUMPF Laser- und Systemtechnik GmbH, Ditzingen (DE)

(72) Inventors: Jonas Kleiner, Leonberg (DE); Daniel Flamm, Ludwigsburg (DE); Malte Kumkar, Weimar (DE); Michael Wendt, Ditzingen (DE)

(21) Appl. No.: 18/338,357

(22) Filed: Jun. 21, 2023

Related U.S. Application Data
(63) Continuation of application No. PCT/EP2021/084593, filed on Dec. 7, 2021.

(30) Foreign Application Priority Data
Dec. 22, 2020 (DE) 10 2020 134 751.0

(51) Int. Cl. B23K 26/38; B23K 26/0622

(52) U.S. Cl. CPC B23K 26/38; B23K 26/0624

(57) ABSTRACT

A method for separating a workpiece includes removing material of the workpiece along a separation line by using a laser beam comprising ultrashort laser pulses of an ultrashort pulse laser. The material of the workpiece is transparent to a wavelength of the laser beam, and has a refractive index between 2.0 and 3.5. The method further includes separating the workpiece along a notch formed by the removal of the material.

### CROSS REFERENCE TO RELATED APPLICATIONS

This application is a continuation of International Application No. PCT/EP2021/084593 (WO 2022/135912 A1), filed on Dec. 7, 2021, and claims benefit to German Patent Application No. DE 10 2020 134 751.0, filed on Dec. 22, 2020. The aforementioned applications are hereby incorporated by reference herein.

### FIELD

Embodiments of the present invention relate to a method for separating a workpiece by using a laser beam comprising ultrashort laser pulses of an ultrashort pulse laser.

### BACKGROUND

In recent years, the development of lasers with very short pulse lengths, e.g., with pulse lengths below one nanosecond, and with high mean powers, e.g., in the kilowatt range, has led to a novel type of material machining. The short pulse length and high pulse peak power, or the high pulse energy of a few 100 μJ, may lead to nonlinear absorption of the pulse energy within the material of a workpiece, with the result that it is even possible to machine materials that actually are transparent or substantially transparent to the laser light wavelength utilized.

A particular field of application for such laser radiation lies in the separation and machining of workpieces. In the process, the laser beam is preferably introduced into the material with perpendicular incidence as this in principle minimizes reflection losses at the surface of the material. However, the separation of materials with a high refractive index is still an unsolved problem, also because a significant aberration of the laser beam arises owing to the large difference in refractive index between the surrounding medium and the material of the workpiece, and thus it is not possible for there to be a targeted deposition of energy in the material.

### SUMMARY

Embodiments of the present invention provide a method for separating a workpiece. The method includes removing material of the workpiece along a separation line by using a laser beam comprising ultrashort laser pulses of an ultrashort pulse laser. The material of the workpiece is transparent to a wavelength of the laser beam, and has a refractive index between 2.0 and 3.5. The method further includes separating the workpiece along a notch formed by the removal of the material.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1A and 1B show a schematic illustration of the method according to some embodiments;

FIGS. 2A, 2B, and 2C show a schematic illustration of a separation step according to some embodiments;

FIGS. 3A, 3B, and 3C show a further schematic illustration of the method according to some embodiments;

FIGS. 4A and 4B show a micrograph of a material provided with a notch according to some embodiments;

FIG. 5 shows a further micrograph of a material provided with a notch according to some embodiments;

FIG. 6 shows a micrograph of a layer system separated by means of the method according to some embodiments;

FIGS. 7A and 7B show a schematic illustration of a non-diffractive beam according to some embodiments;

FIG. 8 shows a schematic illustration of the device for carrying out the method according to some embodiments; and

FIGS. 9A and 9B show a further schematic illustration of the device according to some embodiments.

### DETAILED DESCRIPTION

Embodiments of the present invention provide a method for separating a workpiece, with material of the workpiece being removed along a separation line by means of a laser beam comprising ultrashort laser pulses of an ultrashort pulse laser, the material of the workpiece being transparent to the wavelength of the laser beam and having a refractive index between 2.0 and 3.5, preferably between 2.5 and 3.5, and in a separation step the workpiece is separated along a notch made by the removal of the material.

The ultrashort pulse laser in this case makes ultrashort laser pulses available. In this context, ultrashort may mean that the pulse length is for example between 500 picoseconds and 10 femtoseconds and in particular between 10 picoseconds and 100 femtoseconds. In the process, the ultrashort laser pulses move in the beam propagation direction along the laser beam formed thereby.

In this context, a transparent material is understood to be a material that is substantially transparent to the wavelength of the laser beam of the ultrashort pulse laser. The terms “material” and “transparent material” are used interchangeably herein—which is to say the material specified herein should always be understood to be a material that is transparent to the laser beam of the ultrashort pulse laser.

When the laser beam is incident on the surface of the transparent material from a surrounding medium, for example air, at an angle, the laser beam is refracted at the angle of refraction. In the process, the angle of incidence and the angle of refraction are linked to one another by Snell's law of refraction, using the refractive index of the material of the workpiece and that of the surrounding medium.

Further properties of the laser beam that is reflected and refracted at the surface are given by the Fresnel equations. In this respect, the Fresnel equations describe the polarization-dependent transmission and reflection behavior of the laser beam at the surface. Here, consideration should be given to the law of reflection which states that, in the event of perpendicular incidence of the laser beam on the surface of the material, the following holds true for the reflectance:

$$R = {( \frac{{n}_{a i r} - {n}_{m a t e r i a l}}{{n}_{a i r} + {n}_{m a t e r i a l}} )}^{2} .$$

For example, in the event of a refractive index of the material of n=2.5 and given a refractive index of air n=1, already 18% of the incident laser intensity is reflected at the surface of the material. Accordingly, although the material of the workpiece may be transparent to the wavelength of the laser, it may still be the case that, owing to what are referred to as Fresnel reflections, the laser beam couples into the material only weakly and is transmitted through the material correspondingly weakly.

When an ultrashort laser pulse is focused into a material of the workpiece, the intensity in the focal volume may lead to nonlinear absorption, for example by multi-photon absorption and/or electron avalanche ionization processes. This nonlinear absorption leads to the generation of an electron-ion plasma, and permanent structural modifications may be induced in the material of the workpiece when said plasma cools.

The material modifications introduced into transparent materials by ultrashort laser pulses are subdivided into three different classes: see K. Itoh et al. “Ultrafast Processes for Bulk Modification of Transparent Materials” MRS Bulletin, vol. 31, p. 620 (2006): Type I is an isotropic refractive index change; Type II is a birefringent refractive index change; and Type III is what is known as a void or cavity that is produced by so-called micro-explosions. In this respect, the material modification created depends on laser parameters such as the pulse duration, the wavelength, the pulse energy and the repetition frequency of the laser, on the material properties such as, among other things, the electronic structure and the coefficient of thermal expansion, and also on the numerical aperture (NA) of the focusing.

By way of example, the voids (cavities) of the Type III modifications can be produced with a high laser pulse energy. In this context, the formation of the voids is ascribed to an explosion-like expansion of highly excited, vaporized material from the focal volume into the surrounding material. This process is also referred to as a micro-explosion. Since this expansion occurs within the mass of the material, the micro-explosion results in a less-dense or hollow core (the void), which is surrounded by a densified material envelope. Stresses which may lead to spontaneous formation of cracks or which may promote formation of cracks arise in the transparent material on account of the compaction at the shock front of the micro-explosion.

In particular, when there is a micro-explosion close to the surface, deflagration of the material can occur, with the result that the material is effectively removed close to the surface. The causes of the formation of a void inside a material and of the deflagration of the material at the surface are therefore the same. In particular, “close to the surface” can mean both proximity to the upper surface (here “upper side”) and to the lower surface (here “lower side”) of the workpiece relative to the beam propagation direction.

In the case of high laser repetition rates, the material is unable to cool down completely between the pulses, with the result that the heat present in the material increases from one pulse to the next. By way of example, the laser repetition frequency may be higher than the reciprocal of the thermal diffusion time of the material, with the result that heat accumulation as a result of successive absorptions of laser energy may occur in the focal zone until the melting temperature of the material has been reached. Moreover, a larger region than the focal zone can be melted and vaporized owing to the thermal transport of the heat energy into the areas surrounding the focal zone, which results in the removal of material.

The surface of the material is subject to significant stresses owing to the high refractive index of the material, with the result that material is removed there.

The material is removed along a separation line with the above-mentioned effects. The separation line describes the line of incidence of the laser beam on the surface of the workpiece. For example, the laser beam and the workpiece are displaced relative to one another at a feed speed as a result of a feed, with the result that the laser pulses are incident on the surface of the workpiece at different locations as time passes. In this case, displaceable relative to one another means both that the laser beam can be translationally displaced relative to a stationary workpiece and that the workpiece can be displaced relative to the laser beam. There may also be a movement of both the workpiece and the laser beam. The ultrashort pulse laser emits laser pulses into the material of the workpiece at its repetition frequency while the workpiece and laser beam are moved relative to one another.

The ultrashort laser pulses thus generate a removal of material along the separation line, and therefore a notch is produced in the material surface as the total removal of material.

Among other things, this targetedly damages or weakens the material on the surface, with the result that a predetermined breaking point of the workpiece is formed along the notch. In a subsequent separation step, the workpiece can accordingly be separated along the separation line with particular ease.

The separation step may comprise mechanical separation and/or an etching operation and/or an application of heat and/or a self-separation step.

By way of example, heat may be applied by way of heating of the material or the separation line. For example, the separation line may be heated locally by means of a continuous wave CO2 laser, with the result that the material in the region where the material was weakened expands differently in comparison with the untreated or unmodified material. However, an application of heat may also be realized by way of a hot air flow, or by baking on a hotplate or by heating the material in an oven. In particular, temperature gradients may also be applied within the scope of the separation step. The cracks promoted by the weakening of material thereby experience crack growth, with the result that a continuous and non-catching separation surface may form, by way of which the parts of the workpiece are separated from one another.

Mechanical separation may be produced by applying a tensile or flexural stress, for example by applying a mechanical load to the parts of the workpiece that are separated by the separation line. By way of example, a tensile stress can be applied if opposing forces in the material plane act at a respective point of attack of the force on the parts of the workpiece that are separated by the separation line, with each of the forces pointing away from the separation line. If the forces are not aligned parallel or antiparallel to one another, then this may contribute to the creation of a flexural stress. The workpiece is separated as soon as the tensile or flexural stresses are greater than the binding forces of the material. In particular, a mechanical change can also be obtained by a pulse-like action on the part to be separated. By way of example, a shock can generate a lattice vibration in the material. Tensile and compressive stresses which may trigger crack formation can thus likewise be generated by the deflection of lattice atoms. In particular, such a method overall can then also be referred to as “scribe and break” method, in which a material is typically first of all scribed and then targetedly broken along the defined separation line.

The material can also be separated by etching using a wet-chemical solution, with the etching process preferably preparing the material at the targeted weakening point of the material. The workpiece is separated along the separation line as a result preferably of the weakened parts of the workpiece being etched.

In particular, what is known as self-separation can also be performed by means of targeted crack progression by way of the orientation of the material removal in the material. The crack formation from one removal of material to an adjacent removal of material in this case enables separation of the two parts of the workpiece over the entire surface area without it being necessary to carry out a further separation step.

This is advantageous in that an ideal separation method can be chosen for the respective material of the workpiece, with the result that separation of the workpiece is accompanied by a high-quality separation edge.

With a single pass along the separation line, the removal of material makes it possible to form a notch on the upper side and/or the lower side of the workpiece.

This can be achieved in that the workpiece can be separated in the separation step with particular ease.

For example, the laser beam can be introduced into the material such that the upper side is in the focal zone of the laser beam. As a result, preferably a notch is made in the upper side of the material. For example, the laser beam can also be introduced into the material such that the lower side is in the focal zone of the laser beam. As a result, preferably a notch is made in the lower side of the material.

However, it may also be the case that a notch is made both in the upper side and the lower side at the same time, with the result that only a single pass of the laser beam over the workpiece is necessary.

The difference in refractive index between the surrounding medium and the material of the workpiece may be greater than 1.5.

As described above, the refraction and reflection of the laser beam depend on the refractive indices of the surrounding medium and of the material of the workpiece, in accordance with Fresnel's formulae. In this respect, however, the surrounding medium does not have to be air, but can also be another material, for example glass. The large difference in refractive index ensures here that the refractive properties of the laser beam as it passes from the surrounding medium into the material of the workpiece lead to removal of material close to the surface.

The material may contain silicon or be silicon, or be silicon carbide SiC or contain silicon carbide.

Silicon carbide is transparent in the visible and infrared spectral range but has a refractive index of n>2.5. This results—although the material is transparent to the wavelength of the laser—in large reflection losses.

For example, the workpiece may be a silicon wafer, which is to be singularized into chips.

The workpiece may have a thickness between 100 μm and 2000 μm, preferably 700 μm. For example, the workpiece may have a material thickness of 500 μm. In this respect, the workpiece may also comprise various material layers, that is to say a layer system. In particular, each material layer may be transparent to the wavelength of the laser. This also makes it possible to separate machined and treated wafer systems using the method.

The removal of material can be made up of an areal removal of material on the surface and a localized depthwise removal of material, with it being possible for the localized depthwise removal of material to have a width of more than 10 μm perpendicularly in relation to the separation line and to have a depth of more than 1 μm.

This makes it possible to have the effect that the material stresses are deflected gradually in the depth direction of the material and a smoother separation surface can thus be created by the separation step.

A localized depthwise removal of material has, for example, a diameter of a few micrometers, for instance between 1 μm and 20 μm, while the removal depth is between 0.1 μm and 5 μm. By contrast, an areal removal of material on the surface has, for example, a diameter of 5 to 10 mm and a removal depth of 0 to 10 μm. As a result, the localized depthwise removal of material is limited to a small diameter at a relatively large material depth, while the areal removal of material on the surface is limited to a large diameter and a small material depth.

If the material modifications are introduced overlapping along the separation line, the diameter can be measured perpendicularly in relation to the separation line. By contrast, in the case of separated material modifications, the diameter may also be the maximum diameter of the removal of material.

The laser beam may be a non-diffractive laser beam and have a focal zone which is elongate in the beam propagation direction, preferably have an elongate focal zone of which the length is variable in the beam propagation direction.

In particular, non-diffractive beams and/or Bessel-type beams should be understood to refer to beams for which a transverse intensity distribution is propagation invariant. In particular, a transverse intensity distribution in a longitudinal direction and/or propagation direction of the beams is substantially constant in the case of non-diffractive beams and/or Bessel-type beams.

A transverse intensity distribution should be understood to mean an intensity distribution located in a plane oriented at right angles to the longitudinal direction and/or propagation direction of the beams. Moreover, the focal zone is always understood to mean that portion of the intensity distribution of the laser beam that is greater than the modification threshold of the material. In this respect, the expression “focal zone” clarifies that this portion of the intensity distribution is provided in a targeted manner and an intensity boost in the form of an intensity distribution is obtained by focusing.

In respect of the definition and properties of non-refractive beams, reference is made to the following book: “Structured Light Fields: Applications in Optical Trapping, Manipulation and Organisation”, M. Wördemann, Springer Science & Business Media (2012), ISBN 978-3-642-29322-1. Express reference is made to the entire content of this book.

Accordingly, non-diffractive laser beams are advantageous in that they can have a focal zone which is elongate in the beam propagation direction and is considerably larger than the transverse dimensions of the focal zone. In particular, this makes it possible to generate a removal of material which is elongate in the beam propagation direction, in order to ensure easy separation of the workpiece.

In particular, non-diffractive beams make it possible to create elliptical non-diffractive beams which have a non-radially symmetrical transverse focal zone. By way of example, elliptical quasi non-diffractive beams have a principal maximum which coincides with the center of the beam. The center of the beam is in this case given by the location at which the principal axes of the ellipse intersect. In particular, elliptical quasi non-diffractive beams may emerge from the superposition of a plurality of intensity maxima, wherein, in this case, only the envelope of the intensity maxima involved is elliptical. In particular, it is not necessary for the individual intensity maxima to have an elliptical intensity profile.

The diameter of the transverse focal zone may be smaller than 5 μm and/or the length of the longitudinal focal zone may be larger than 50 μm and/or the length of the longitudinal focal zone may be smaller than 1.2 times the material thickness.

The small diameter makes it possible to have the effect that clean separation surfaces can be created by the separation step, since the removal of material and thus the targeted weakening of material can be oriented on the separation line with particular precision. In particular a large depthwise removal of material is achieved by the large longitudinal focal zone, with the result that the material is weakened along the separation line and the later separation surface is predefined with particular precision. If, in this respect, the longitudinal focal zone is more than 1.2 times the material thickness, it is moreover possible to make notches in the upper side and the lower side of the workpiece with particular ease.

The focal zone which is elongate in the beam propagation direction can penetrate the upper side of the workpiece and/or penetrate the lower side of the workpiece and/or penetrate both sides.

This makes it possible to weaken the material targetedly along the separation line, with the result that easy separation by the separation step can be realized.

By virtue of the elongate focal zone penetrating only the upper side of the workpiece, a notch can preferably be made on the upper side. By virtue of the elongate focal zone penetrating only the lower side of the workpiece, a notch can preferably be made on the lower side. In particular, an elongate focal zone also makes it possible to make a notch on the upper side and the lower side, if the length of the elongate focal zone is longer than the material thickness.

The non-diffractive beam can be produced by an axicon, a diffractive optical element or a reflective or refractive optical free-form surface.

By way of example, the beam shaping optical unit can be in the form of a diffractive optical element (DOE), a free-form surface or an axicon or a micro-axicon, or may contain a combination of a plurality of these component parts or functionalities. If the beam shaping optical unit shapes a non-diffractive laser beam from the laser beam upstream of the processing optical unit, then it is possible by way of the focusing of the processing optical unit to determine the depth at which the focal zone is introduced into the material. However, the beam shaping optical unit may also be configured in such a way that the non-diffractive laser beam is only generated by way of imaging with the processing optical unit.

A diffractive optical element is configured to influence one or more properties of the incident laser beam in two spatial dimensions. A diffractive optical element is a fixed component which can be used to produce a non-diffractive laser beam from the incident laser beam. Typically, a diffractive optical element is a diffraction grating, with the incident laser beam being brought into the desired beam shape by the diffraction.

An axicon is a conically ground optical element which shapes a non-diffractive laser beam from an incident Gaussian laser beam as the latter passes through. In particular, the axicon has a cone angle α′ which is calculated from the beam entrance surface to the lateral surface of the cone. As a result, the marginal rays of the Gaussian laser beam are refracted to a different focal spot than near axis rays. In particular, this yields a focal zone which is elongate in the beam propagation direction.

The non-diffractive beam can be transferred to the workpiece by a telescope.

In this respect, a telescope is an optical structure or a processing optical unit which enables imaging of the laser beam, or together with the beam shaping optical unit makes a non-diffractive beam available in or on the material. In particular, such a telescope may have a size increasing and/or reducing action.

In particular, some of the optical functionality of the telescope may be integrated in the beam shaping optical unit. For example, the axicon may have a spherically ground back side, with the result that it combines the beam shaping functionality with a lens effect.

An increase or a reduction in the size of the laser beam or in its transverse intensity distribution allows the laser beam intensity to be distributed over a large or small focal zone. As a result of distributing the laser energy over a large or small area, the intensity is adapted such that, in particular, it is also possible to make a choice between modification types I, II and III by way of the size increase and/or reduction.

In particular, the increase or reduction in the size of the non-radially symmetrical transverse intensity distribution can also realize increased or reduced removal of material. Moreover, the optical system can be adapted to match the given machining conditions by way of a size increase or reduction, with the result that the device can be used more flexibly.

The pulse duration of the ultrashort laser pulses may be between 100 fs and 100 ns, preferably between 100 fs and 10 ps, and/or the average laser power may be between 1 W and 1 kW, preferably may be 50 W, and/or the wavelength may be between 300 nm and 1500 nm, preferably may be 1030 nm, and/or the laser pulses may be individual laser pulses or part of a laser burst, a laser burst comprising between 1 and 20, preferably between 1 and 4 laser pulses, and/or the repetition rate of the individual laser pulses and/or laser bursts may be 100 kHz and/or the pulse or burst energy may be between 100 and 50 mJ.

This makes it possible to set the optimum machining parameters for each material.

The workpiece and the laser beam may be moved relative to one another at a feed speed, the feed speed preferably being between 0.05 m/s and 5 m/s.

By moving the laser beam and the workpiece relative to one another, the material can be removed along the separation line.

In particular, such a feed can be achieved with an axis device. For example, an axis device is an XYZ table which is displaceable in translation along all spatial axes. However, it may also be the case that the axis device can also be rotated about certain axes, with the result that high-quality round and/or curved separation lines can be created.

The laser pulses or laser bursts can be introduced into the material with a spatially constant spacing.

A local reduction in the feed speed may be advantageous in the case of curved or polygonal feed trajectories. However, a constant repetition frequency of the laser may lead to the overlap of adjacent material modifications or to unwanted heating and/or melting of the material. For this reason, control electronics are able to control the pulse emission on the basis of the relative position of laser beam and workpiece.

By way of example, the feed device may comprise a spatially resolving encoder which measures the position of the feed device and laser beam. An appropriate trigger system of the control electronics may trigger the pulse emission of a laser pulse at the ultrashort pulse laser on the basis of the spatial information.

In particular, computer systems may also be used to trigger the pulses. By way of example, the locations of the laser pulse emission may be defined for the respective separation line prior to the machining of the material, with the result that an optimum distribution of the laser pulses along the separation line is ensured.

What this achieves is that the spacing of the material modifications is always the same, even if the feed speed varies. In particular, what this also achieves is that it is possible to produce a uniform separation surface, and the separation surface has a high surface quality.

Preferred exemplary embodiments are described below with reference to the figures. In this case, elements that are the same, similar or have the same effect are provided with identical reference designations in the different figures, and a repeated description of these elements is omitted in some instances, in order to avoid redundancies.

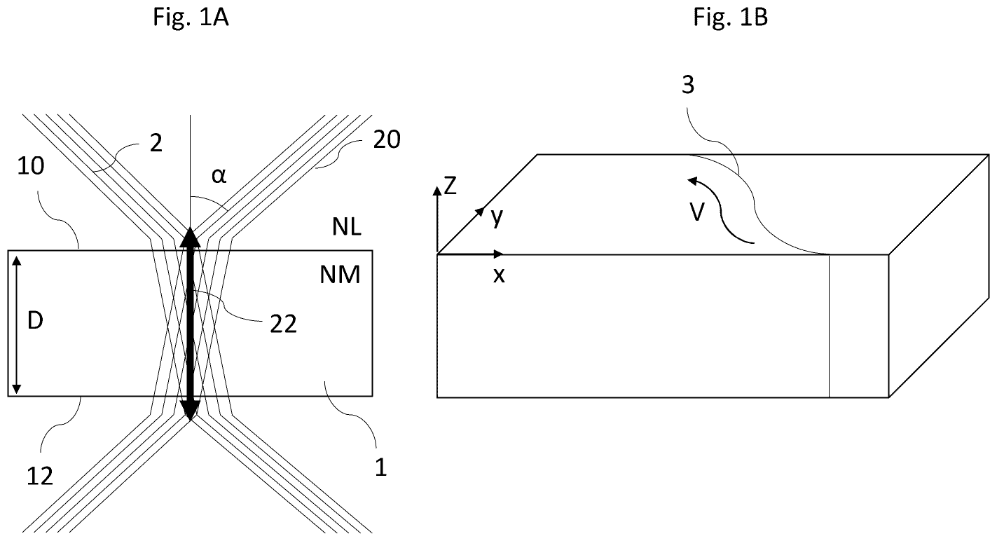

FIG. 1A schematically shows a workpiece 1, the material of which has a high refractive index NM. A laser beam 2, which in this respect is focused such that the component laser rays 20 of the laser beam 2 are incident on the upper side 10 of the workpiece 1 at an angle of incidence a, is brought onto the workpiece 1. Here, the laser beam 2 is incident for example from the air with a refractive index of NL=1 on the surface 10 of the workpiece 1.

The workpiece 1 is in particular transparent to the wavelength of the laser beam 2. Therefore, the laser beam 2, or its component laser rays 20, is refracted on the basis of the refraction indices NM, NL and on the angle of incidence a in accordance with the Fresnel formulae.

For example, the material of the workpiece 1 is silicon carbide with a refractive index of NM=2.5. In particular, the difference in refractive index between the material of the workpiece 1 and the surrounding medium is then greater than 1.5, with the result that the refraction effect is significant. The material of the workpiece 1 may have a material thickness D between D=100 μm and D=2000 μm, for instance D=700 μm.

A non-diffractive laser beam 2, which has a focal zone 22 that is elongate in the beam propagation direction, is formed in the material of the workpiece 1, for example owing to the conically tapering component laser rays 20. Here, the elongate focal zone 22 penetrates the upper side 10 and the lower side 12 of the material of the workpiece 1. The material of the workpiece 1 is vaporized in the elongate focal zone 22 by nonlinear absorption effects, resulting in removal of material on the upper side 10 and the lower side 12.

Moreover, it is possible for surface modification, for example deformation or removal of material, to occur on the upper side 10 owing to the nonlinear absorption effects, with the result that there is not an ideal non-diffractive beam 2 at least in the region close to the surface. However, the non-diffractive laser beam 2 can then be formed after penetrating the region close to the surface, for example owing to self-healing effects. Accordingly, in the description, the laser beam 2 is described as non-diffractive beam 2, such surface effects also being considered.

FIG. 1B shows that the material is removed along the separation line 3. For this, the workpiece 1 and the laser beam 20 can be moved relative to one another with a feed V between V=0.05 m/s and V=5 m/s. By weakening the material of the workpiece 1 targetedly along the separation line 3, a predetermined breaking point, along which the workpiece 1 can be separated with a subsequent separation step, is formed along the separation line 3.

In particular, the pulse duration of the ultrashort laser pulses may be between 100 fs and 100 ns, preferably between 100 fs and 10 ps, and/or the average laser power may be between 1 W and 1 kW, preferably may be 50 W, and/or the wavelength may be between 300 nm and 1500 nm, preferably may be 1030 nm, and/or the laser pulses may be individual laser pulses or part of a laser burst, a laser burst comprising between 1 and 20, preferably between 1 and 4 laser pulses, and/or the repetition rate of the individual laser pulses and/or laser bursts may be 100 kHz and/or the pulse or burst energy may be between 100 μJ and 5 mJ.

Owing to the repetition rate R of for example R=100 kHz, together with the feed speed V it is possible to estimate the spacing between impingement locations of the laser pulses at 0.5 μm to 50 μm.

Here, the laser beam 20 may have a focal zone 22 which has a diameter perpendicular to the beam propagation direction of less than 5 μm. This makes it possible to orient the removal of material by the laser beam 20 precisely on the separation line 3. For the one part, the various laser pulses can lie one on top of another or spatially overlap, such that heat accumulates in the material of the workpiece 1, as a result of which the material of the workpiece 1 is weakened. For the other part, however, it is also possible for the laser pulses to be far enough apart that the material of the workpiece 1 is perforated along the separation line 3 merely at the surface.

FIG. 1A likewise shows that the length of the focal zone 22 of the laser beam 20 that is elongate in the beam propagation direction is larger than the material thickness D. In particular, the depicted focal zone 22 of the laser beam is 800 μm long, with the result that it is larger than 50 μm, but also smaller than 1.2 times the material thickness D. This has the effect that the laser beam 20 in conjunction with the feed V can make notches both on the upper side and the lower side of the material of the workpiece 1. In particular, this therefore ensures that the elongate focal zone 22 penetrates the upper side 10 and the lower side 12.

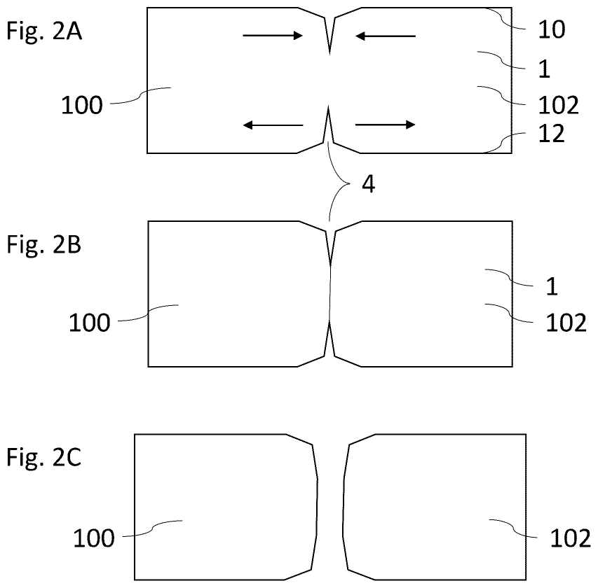

FIG. 2 shows a possible separation step which involves applying mechanical loading to the material of the workpiece 1. FIG. 2A in particular shows that the notches 4 were made by the non-diffractive laser beam 20 of FIG. 1A both on the upper side 10 and the lower side 12.

As mechanical force, for example, a flexural stress can be applied to the parts 100, 102 of the workpiece 1 which are to be separated. A flexural stress can have the effect of compressing the material of the workpiece 1 on the upper side 10 toward the notch 4, while the material of the workpiece 1 on the lower side 12 is stretched away from the notch. This results in a stress gradient which is directed from the lower side 12 to the upper side 10. As soon as the material stresses along the stress gradient are greater than the binding forces in the material of the workpiece 1, the material of the workpiece 1 relaxes with formation of a crack, which runs for example from the notch 4 in the upper side 12 to the notch 4 in the lower side 12 of the material of the workpiece 1. This state of the material of the workpiece 1 is shown in FIG. 2B in this respect. FIG. 2C shows the subsequent state, in which the parts 100, 102 of the workpiece are singularized and separate. The workpiece 1 was accordingly separated along the separation line 3.

Such a separation step may in particular also be realized by applying a thermal gradient, for example by irradiating the notches 4 with a CO2 continuous wave laser. As an alternative, it is also possible to etch the material of the workpiece 1 along the notches 4 in a chemical bath, with the targeted weakening of material making it possible to selectively etch the material of the workpiece 1. A further possibility is also for the material stress to exceed the binding forces owing to the targeted weakening of material with Type III modifications, with the result that a self-separation process of the workpiece 1 occurs. In any case, however, the weakening of material along the separation line 3 predefines the direction of the separation process.

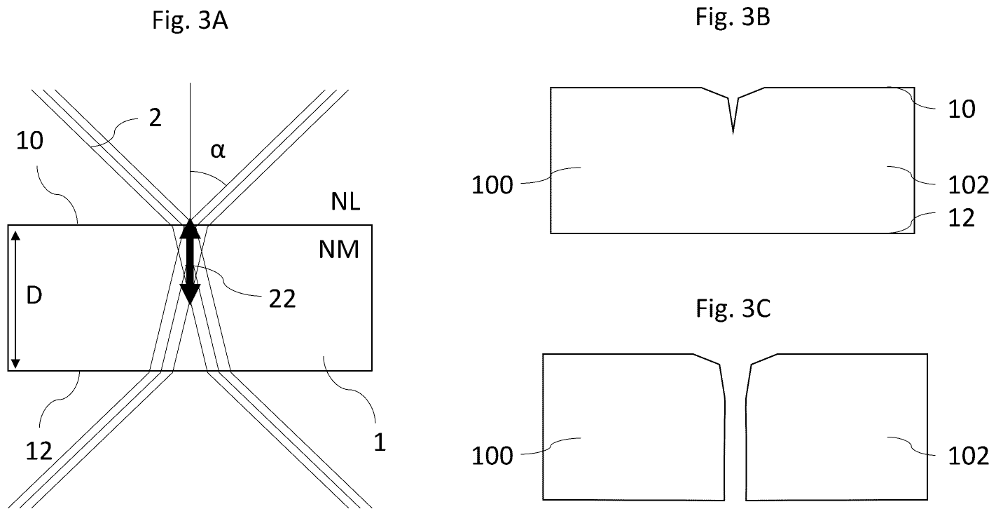

FIG. 3A shows the method, in the course of which the focal zone 22 of the laser beam 20 is shorter than the material thickness D and makes a notch 4 merely in the upper side 10 of the material of the workpiece 1. However, the notch 4 in the upper side 10 of the workpiece is also sufficient to bring about targeted weakening of material, with the result that the workpiece 1 can be separated along the separation line 3 with a separation step. This is shown by way of example in FIGS. 3B and C, where the parts 100, 102 of the workpiece 1 are separated by a separation step.

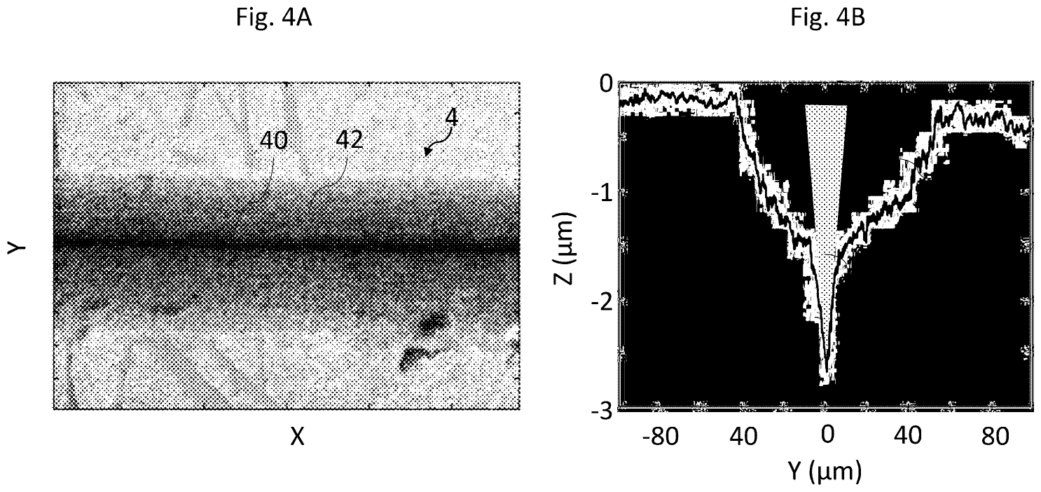

FIG. 4A shows a micrograph of the upper side 10 of a workpiece 1, which was subjected to a non-diffractive laser beam 20. FIG. 4B shows the associated height profile along the y direction. It can be clearly seen that the notch 4 is composed of a localized depthwise removal 40 of material and an areal removal 42 of material on the surface. The removal 42 of material on the surface may in this respect be part of the above-mentioned surface modification. The depth of the respective removal of material is calculated from the original surface 10 of the workpiece 1 here. Therefore, in the present case a depthwise removal 40 of material of 2.5 μm is produced, while the removal 42 of material on the surface has a removal depth of 1.5 μm. Moreover, the removal 42 of material on the surface has a diameter, or cross section, of 80 μm, while the cross section of the depthwise removal of material measures just 20 μm.

The depthwise removal 40 of material and the removal 42 of material on the surface come about when the laser beam 20 is incident on the upper side 10 of the material of the workpiece 1. Then, removal 42 of material on the surface is carried out first of all over the entire width of the laser beam 20. The removal 42 of material on the surface and the edges produced at the border of the removal of material, however, act—also owing to the large refractive index of the material—as a shield. This displaces the formation of the non-diffractive laser beam to deeper material layers, with the result that only there does the elongate focal zone 22 manifest and thus depthwise removal 40 of material occurs.

The manifestation of the notch 4 can moreover also reflect the intensity distribution of the laser beam 20 or the shape of the focal zone 22. By virtue of the formation of a notch 4 being based on nonlinear absorption effects, as described above, the central portion of the laser beam can for example form notches 4 effectively, while component laser rays that are close to the edge cannot do this.

Furthermore, FIGS. 4A and B show that the notch is continuous on the material upper side 10. Accordingly, in the present case the feed speed or the repetition rate of the laser was high enough that adjacently introduced laser pulses overlap and thus create a continuous predetermined breaking point on the upper side 10 of the workpiece 1. In particular, it was accordingly also possible to make the notch 4 in a single method step.

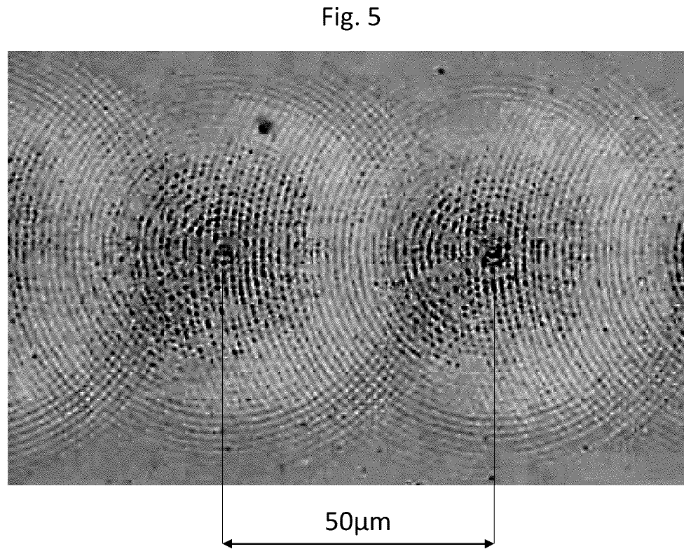

FIG. 5 shows the perforation of a material of a workpiece 1 along a separation line 3. Here, the laser pulses were introduced into the material of the workpiece with a spacing of 50 μm. In this respect, the spacing between the laser pulses can result in particular from the repetition frequency R of the laser and the feed speed V. Here, the removal of material on the surface takes the form of concentric diffraction rings, with the thickness of the removal of material increasing toward the center. In this region, the removal 42 of material on the surface transitions into the localized depthwise removal 40 of material.

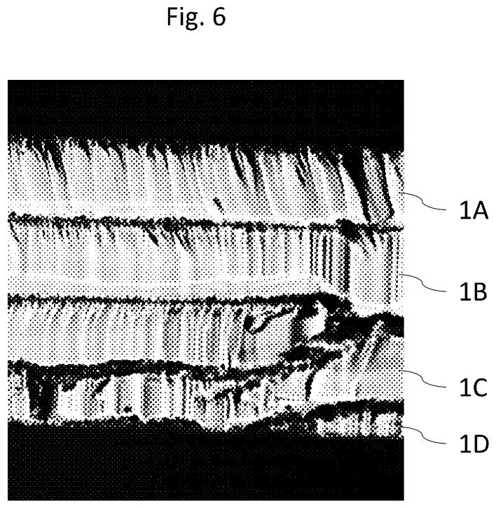

FIG. 6 shows that the workpiece 1 can also comprise a layer system of various materials 1A-1D. In particular, the use of a non-diffractive laser beam 20 of which the focal zone 22 is longer than the entire material thickness D, that is to say the sum of all material thicknesses of the workpiece 1, makes it possible to achieve the material removal threshold even in the transition region between the layers 1A-1D. In this respect, the material removal threshold is the intensity threshold from which the material of the workpiece 1 is removed and can be increased or at least varied on the basis of the chemical boundary conditions. In particular, here each material layer can have a refraction index between 2.0 and 3.5.

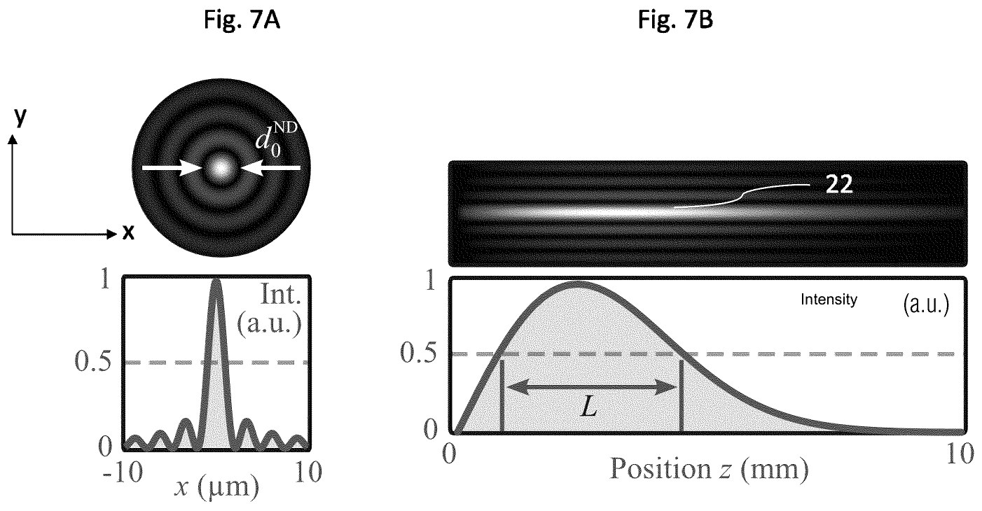

FIG. 7A shows the transverse intensity distribution or the focal zone 22 of a non-diffractive laser beam 20. The non-diffractive laser beam 20 is what is known as a Bessel-Gauss beam, with the transverse intensity distribution in the xy-plane being radially symmetrical, and so the intensity of the non-diffractive laser beam 20 only depends on the radial distance from the optical axis. In particular, the diameter of the transverse intensity distribution is smaller than 5 μm. FIG. 7B shows the longitudinal beam cross section, which is to say the longitudinal intensity distribution. The longitudinal intensity distribution has an elongate region of high intensity, with a size of approximately 3 mm. Hence, the longitudinal extent of the focal zone 22 is significantly greater than the transverse extent.

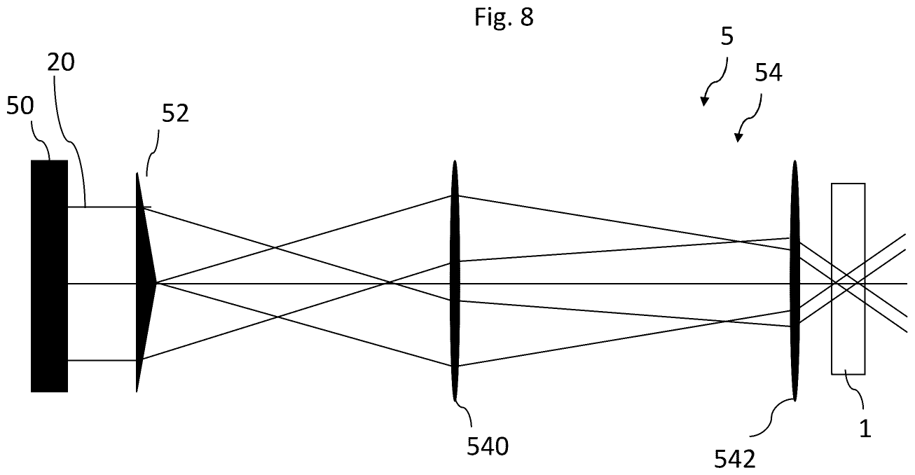

FIG. 8 shows an embodiment of the device 5 for carrying out the method. In this case, the laser pulses are provided by the ultrashort pulse laser 50 and steered through a beam shaping optical unit 52. The beam shaping optical unit 52 steers the laser beam 20 to the material 1, for example through a telescope system 54 or another type of processing optical unit.

In the example shown, the beam shaping optical unit 52 is an axicon for shaping the incident laser beam 20 into a non-diffractive laser beam 20. However, the axicon may also be replaced by other elements for the purpose of generating a non-diffractive laser beam. The axicon generates a conically tapering laser beam 20 from the preferably collimated input beam 20. In this context, the beam shaping optical unit 52 may also impress a non-radially symmetrical intensity distribution, or focal zone 22, on the incident laser beam 20. Lastly, the laser beam 20 can be imaged into the material 1 via a telescope optical unit 54, which consists of two lenses 540, 542 here, with it being possible for the imaging to be an imaging with increase or reduction in size. However, it is also possible for parts of the telescope optical unit 54, in particular the first lens 540, to be integrated in the beam shaping optical unit 52.

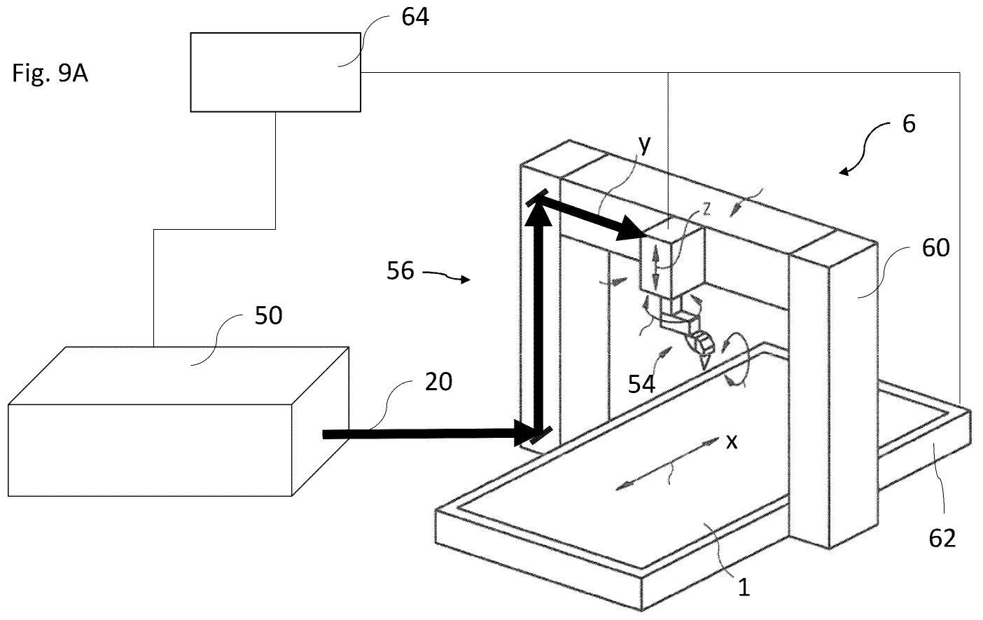

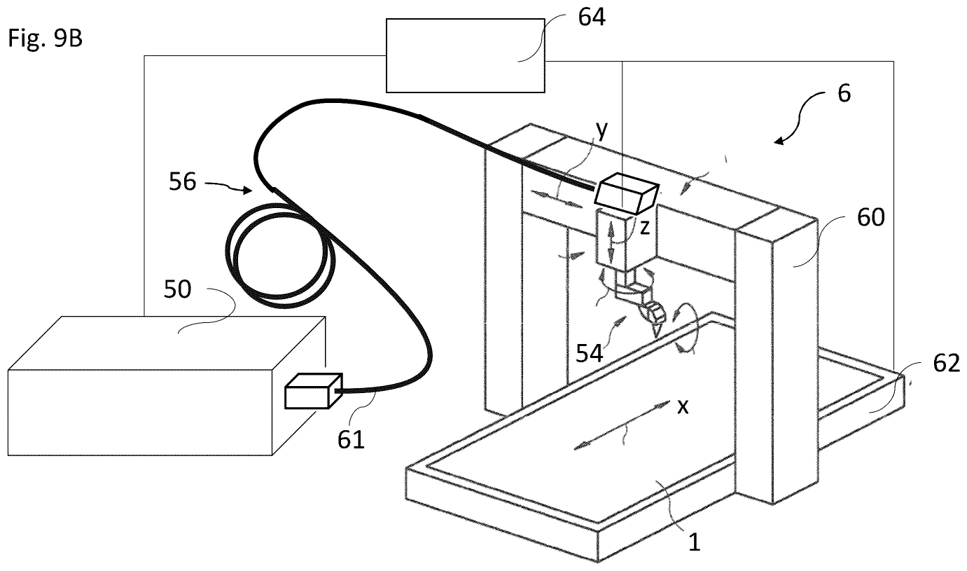

FIG. 9A shows a feed device 6 configured to move the processing optical unit 54 and the material 1 in translation along three spatial axes XYZ. The laser beam 20 of the ultrashort pulse laser 50 is steered onto the workpiece 1 by a processing optical unit 54. In this case, the material 1 is disposed on a support surface of the feed device 6, with the support surface preferably neither absorbing the laser energy which was not absorbed by the material nor significantly reflecting this laser energy back into the material 1.

In particular, the laser beam 20 can be coupled into the processing optical unit 54 by way of a beam guiding device 56. In this case, the beam guiding device 56 may be a free-space path with a lens and mirror system, as shown in FIG. 9A. However, the beam guiding device 56 may also be a hollow core fiber with an input coupling and output coupling optical unit, as shown in FIG. 9B.

In the present example of FIG. 9A, the laser beam 20 is steered in the direction of the material 1 by a mirror structure and introduced into the material 1 by the processing optical unit 54. The laser beam 20 causes material to be removed in the material 1. The processing optical unit 54 can be moved and adjusted relative to the material by means of the feed device 6, for example such that a preferred direction or an axis of symmetry of the transverse intensity distribution of the laser beam 20 can be adapted to the feed trajectory, and hence to the separation line 3.

In this case, the feed device 6 can move the material 1 under the laser beam 20 with a feed V such that the laser beam 20 makes a notch in the workpiece 1 along the desired separation line 3. In particular, in the shown FIG. 9A, the feed device 6 comprises a first axis system 60, by means of which the material 1 can be moved along the XYZ axes and can optionally be rotated. In particular, the feed device 6 may also comprise a workpiece holder 62 which is configured to hold the material 1.

The feed device 6 may in particular also be connected to control electronics 64, the control electronics 64 converting the user commands of a user of the device into control commands for the feed device 6. In particular, predefined cutting patterns may be stored in a memory of the control electronics 64 and the processes may be automatically controlled by the control electronics 64.

The control electronics 64 may in particular also be connected to the ultrashort pulse laser 50. In this context, the control electronics 64 may demand or trigger the emission of a laser pulse or a laser pulse train. The control electronics 64 may also be connected to other specified components and thus coordinate the machining of material.

In particular, a position-controlled pulse trigger can be realized in this way, with for example an axis encoder 600 of the feed device 6 being read out and it being possible for the control electronics 64 to interpret the axis encoder signal as a location specification. Consequently, it is possible that the control electronics 64 automatically trigger the emission of a laser pulse or laser pulse train, for example if an internal adder unit, which adds the traversed path length, reaches a value and resets to 0 after this value has been reached. Thus, for example, a laser pulse or laser pulse train can be automatically emitted into the material 1 at regular intervals.

By virtue of it being possible to also process the feed speed V and the feed direction, and hence the separation line 3, in the control electronics 64, there can be automated emission of the laser pulses or laser pulse trains.

The control electronics 64 are also able to calculate, on account of the measured speed and the fundamental frequency provided by the laser 2, the distance or a location at which a laser pulse train or laser pulse should be emitted. This in particular makes it possible to have the effect that the material modifications 5 in the material 1 do not overlap, or the laser energy is emitted uniformly along the separation line 3.

By virtue of the emission of the laser pulses or the pulse trains being implemented under position control, complicated programming of the separation process can be dispensed with. Moreover, freely selectable process speeds can be implemented easily.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Workpiece
10 Upper side
12 Lower side
2 Laser beam
20 Component laser rays
3 Separation line
4 Notch
40 Depthwise removal of material
42 Removal of material on the surface
5 Device
50 Ultrashort pulse laser
52 Beam shaping optical unit
54 Telescope system
56 Beam guiding optical unit
6 Feed device
60 Axle system
62 Workpiece holder
64 Control electronics

1. A method for separating a workpiece, the method comprising:
removing material of the workpiece along a separation line by using a laser beam comprising ultrashort laser pulses of an ultrashort pulse laser, the material of the workpiece being transparent to a wavelength of the laser beam and having a refractive index between 2.0 and 3.5, and
separating the workpiece along a notch formed by the removal of the material.

2. The method as claimed in claim 1, wherein the separation of the workpiece comprises mechanical separation, and/or an etching operation, and/or an application of heat, and/or a self-separation.

3. The method as claimed in claim 1, wherein, with a single pass of the laser beam along the separation line, the removal of material of the workpiece causes formation of the notch on an upper side and/or a lower side of the workpiece.

4. The method as claimed in claim 1, wherein the removal of material of the workpiece comprises an areal removal of material on a surface and a localized depthwise removal of material, wherein the localized depthwise removal of material results in a material modification having a width of more than 10 μm perpendicularly to the separation line and a depth of more than 1 μm.

5. The method as claimed in claim 1, wherein a difference in refractive index between a surrounding medium and the material of the workpiece is greater than 1.5.

6. The method as claimed in claim 1, wherein the material of the workpiece comprises silicon, or comprises silicon carbide.

7. The method as claimed in claim 1, wherein the workpiece has a thickness between 100 μm and 2000 μm.

8. The method as claimed in claim 1, wherein the laser beam is a non-diffractive laser beam and has a focal zone that is elongate in a beam propagation direction.

9. The method as claimed in claim 8, wherein a length of the focal zone in the beam propagation direction is variable.

10. The method as claimed in claim 8, wherein
a diameter of the focal zone in a transversal direction is smaller than 5 μm, and/or
a length of the focal zone in the beam propagation direction is greater than 50 μm, and/or
the length of the focal zone in the beam propagation direction is less than 1.2 times a thickness of the material.

11. The method as claimed in claim 8, wherein the focal zone penetrates an upper side of the workpiece, and/or penetrates a lower side of the workpiece, and/or penetrates both the upper side and the lower side of the workpiece.

12. The method as claimed in claim 8, wherein the non-diffractive laser beam is created by an axicon, or a diffractive optical element, or a reflective or refractive optical free-form surface.

13. The method as claimed in claim 8, wherein the non-diffractive laser beam is transferred to the workpiece by a telescope.

14. The method as claimed in claim 1, wherein
a pulse duration of the ultrashort laser pulses is between 100 fs and 100 ns, and/or
an average laser power of the laser beam is between 1 W and 1 kW, and/or
the wavelength of the laser beam is between 300 nm and 1500 nm, and/or
the laser pulses are individual laser pulses or part of a laser burst, with a laser burst comprising between 1 and 20 laser pulses, and/or
a repetition rate of the individual laser pulses and/or the laser bursts is 100 kHz, and/or
a pulse energy and/or a laser burst energy is between 10 μJ and 50 mJ.

15. The method as claimed in claim 1, wherein the workpiece and the laser beam are moved relative to one another at a feed speed, the feed speed being between 0.05 m/s and 5 m/s.

16. The method as claimed in claim 1, wherein the laser pulses are introduced into the material of the workpiece at a spatially constant spacing.
